(19) United States
(12) Patent Application Publication
(10) Pub. No.: US 2005/0131807 A1
(43) Pub. Date: Jun. 16, 2005

(54) Balanced budget update in the presence of rib rules

(76) Inventors: Andreas Schaefer, Mougins (FR); Horst Schnoerer, Angelbachtal (DE); Thomas Schaub, Antibes (FR)

Correspondence Address: KENYON & KENYON, 1500 K STREET, N.W., SUITE 700, WASHINGTON, DC, 20005, US

(21) Appl. No.: 10/730,948

(22) Filed: Dec. 10, 2003

(51) Int. Cl. G06F 17/60; G06F 17/00

(52) U.S. Cl. 705/39; 707/100

(57) ABSTRACT

A budgetary control system is described that maintains balance between revenue and expenditure budgets even when the expenditure budgets increase due to “revenues increasing the budget” (RIB) effects. RIB increases to an expenditure budget may be recorded in parallel to a revenue budget. Doing so maintains balance between the two budget data structures. During auditing operations or other control checks that examine the budget data structures for balance, RIB increases to the expenditure budget are counter-balanced by corresponding increases to the revenue budget. In the revenue budget, RIB increases may be isolated from a ‘base’ budget to ensure that the RIB increases do not effect other budgetary controls unintentionally.

### BACKGROUND

Enterprise management applications (“EMAs”) are computer systems that help organizations to manage their operations and, among other things, ensure that certain financial goals are met. For example, an organization's employees might be compelled to generate purchase orders or other expenditure documents using the EMA. Before the purchase order could be transmitted to a vendor organization, a financial management component of the EMA may compare the purchase order against expenditure budget values established for the organization. If the purchase order includes an expenditure item that violates one or more budgetary requirements set for the organization, the EMA may prevent the purchase order from being completed. EMAs, therefore, maintain data structures that establish expenditure budgets and track aggregate actual posted expenditures during the organization's fiscal operations. They may compare new expenditure transactions to budgetary requirements before permitting the transactions to be completed.

Some organizations permit expenditure budget limits to vary based on revenue that the organizations earn during its fiscal operations. For example, an organization may be permitted to spend additional monies pursuant to an identified program if its revenues exceed a predetermined threshold amount. Such budgetary dependencies are called “revenues increasing the budget” (or simply, “RIB”) and vary widely in their implementation. When a new revenue item is posted within the system, the EMA system may apply one or more RIB rules to determine whether the revenue item causes an increase in some expenditure budget item. The EMA system may amend values in the expenditure budget database to reflect any RIB increase that the new revenue item may cause.

EMAs also maintain databases to record revenue budgets that are defined for an organization. Revenue budgets typically forecast revenues that the organization expects to earn over a predetermined fiscal period. The process of defining revenue budget values and expenditure budget values is an integrated process. Many organizations, particularly public sector organizations, require that the revenue budget and the expenditure budget remain balanced.

Through the course of the fiscal period, as the organization posts revenue and RIB increases are made to the expenditure database, values of the expenditure budget database no longer balance with the revenue budget database. When audit functions are performed, this artifact causes difficulty to determine whether the organization's goals are being met. Accordingly, there is a need in the art for a budgetary control system that demonstrates balance between revenue and expenditure budget structures even when the expenditure budget increases according to RIB rules.

### BRIEF DESCRIPTION OF THE DRAWINGS

FIG. 1 is a functional block diagram of an embodiment of the present invention.

FIG. 2 is a functional block diagram of another embodiment of the present invention.

FIGS. 3(a) and 3(b) are graphs illustrating audit results that may occur with and without the benefits of the present invention.

FIG. 4 is a simplified block diagram of a computer system finding application with the present invention.

### DETAILED DESCRIPTION

Embodiments of the present invention provide a budgetary control system that maintains balance between revenue and expenditure budgets even when the expenditure budgets increase due to RIB effects. According to the embodiment, RIB increases to an expenditure budget are recorded in parallel to a revenue budget. This embodiment maintains balance between the two budget data structures. During auditing operations or other control checks that examine the budget data structures for balance, RIB increases to the expenditure budget are counter-balanced by corresponding increases to the revenue budget. In the revenue budget, RIB increases may be isolated from a ‘base’ budget to ensure that the RIB increases do not affect other budgetary controls unintentionally.

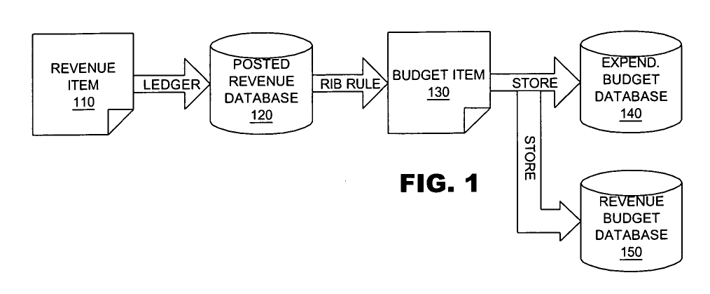

FIG. 1 is a functional block diagram of an RIB process flow according to an embodiment of the present invention. During operation of a financial management application, a revenue item 110 may be posted to a revenue database 120. Budgetary processing applications may apply one or more RIB rules to the posted revenue item, which could generate a budget item 130 representing a change in an expenditure budget value. The budgetary processing application would store the budget item to an expenditure budget database 140. By virtue of this process, the expenditure budget limits that the EMA uses to determine whether to authorize new expenditure transactions change over time as new revenue postings occur. In this regard, the operation of the EMA system is well known.

Embodiments of the present invention provide for an increase in revenue budget items to occur as a result of new revenue postings. Thus, a RIB increase to an expenditure budget also is stored in corresponding entry of a revenue budget database 150 as an increase to a revenue budget. Thus, as expenditure budget values increase due to new revenue postings, corresponding revenue budget items also will increase to maintain revenue budget values in balance with expenditure budget values. Thus, as audits or other ongoing performance evaluations are performed using data from the revenue and expenditure budget databases, the databases will reflect a balance between them, even when factoring in RIB influenced budget values.

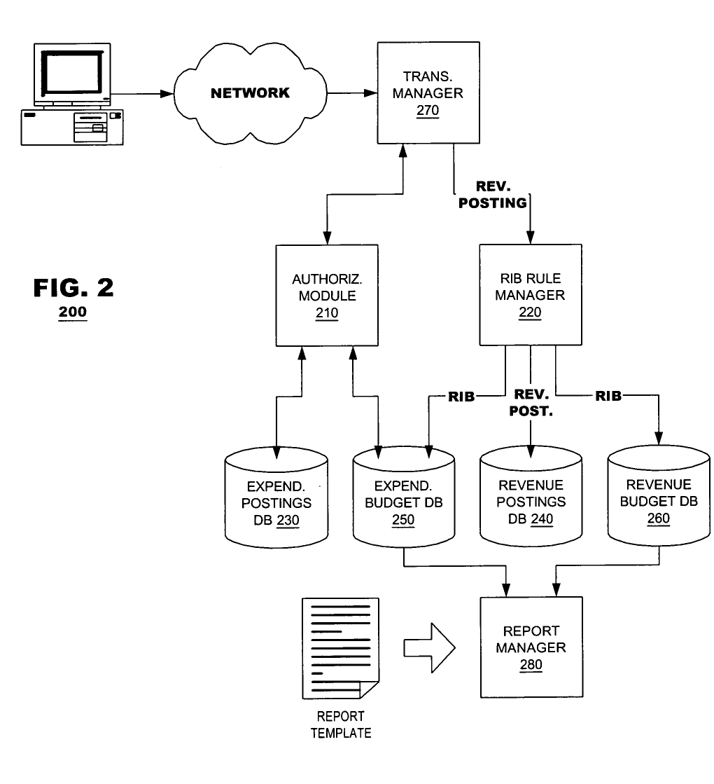

FIG. 2 illustrates a EMA system 200 according to another embodiment of the present invention. The EMA system may include an expenditure authorization module 210, a RIB rule manager 220 and one or more databases storing posted expenditure transactions (230), posted revenue transactions (240), expenditure budget (250) and revenue budget (260). EMAs are commercially available from the assignee of the present invention, SAP AG, and from others. They typically include a variety of applications such as materials management applications, financial management applications, supply chain management applications, product lifecycle applications and others. Implementations vary for different users and, therefore, some EMA installations may include a greater or fewer number of application modules than others. For the purposes of the present discussion, such applications modules may be deemed to reside in the transaction manager 270 illustrated in FIG. 2.

During operation, an operator may post a transaction at terminal T having a revenue item therein. The transaction manager 270 upon detecting the revenue item, may engage the EMA 200 and communicate information regarding the revenue item. A RIB rule manager 220 may execute one or more RIB rules in response to the revenue item and generate a RIB budget item to be stored in a location of the expenditure budget database 250 as specified in the RIB rule. The RIB rule manager 220 stores the RIB budget item in a corresponding location in the revenue budget database 260 as well. The EMA 200 also may store the revenue posting in the revenue posting database 240. In an embodiment, the RIB budget item stored in the revenue database 260 may be marked to be excluded from RIB expenditure budget calculations to avoid double-counting issues.

A revenue data system 260 may be established where RIB budget increases are distinguished from other revenue budget items. Accordingly, it becomes possible to define budgetary reports and other audit mechanisms that either include or exclude the RIB budget increases as needs dictate. A first report may be designed to include all revenue items, regardless of whether they arise from RIB budget increases or from another source (e.g., originally planned revenue budget items). A second report may exclude RIB budget increases but include revenue items from other sources. A third report may include only the RIB budget increases. Such reports will be defined to satisfy the needs of the EMA operators. Responsive to a report template, a report manager 280 may collect identified budget items from the revenue budget database 260 and generate a report therefrom.

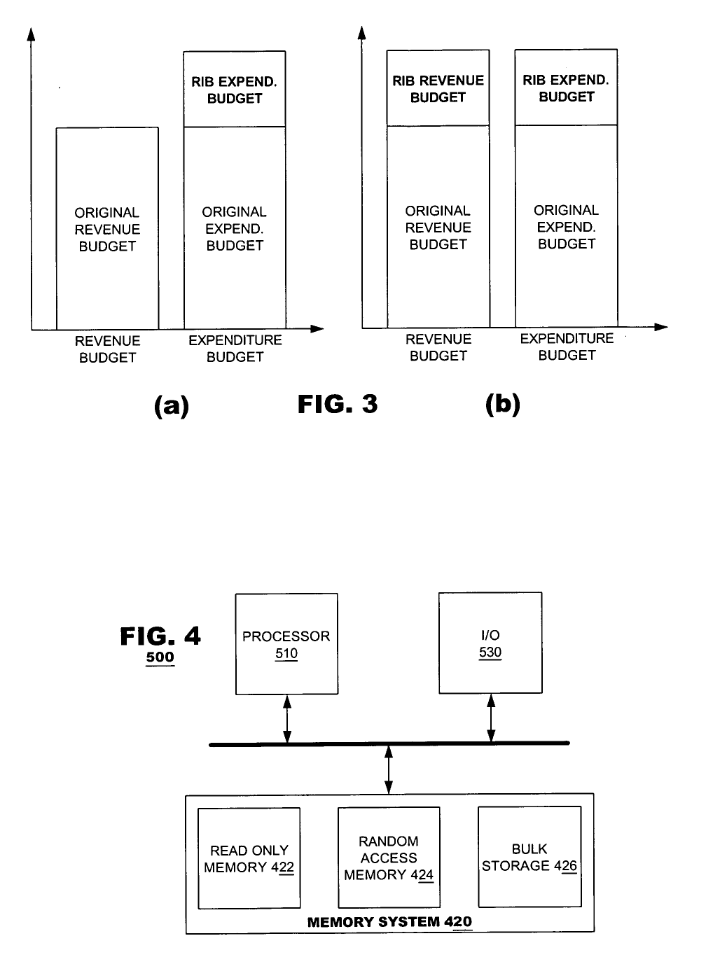

FIGS. 3(a) and 3(b) are graphs illustrating exemplary budget reports that might be generated by report managers with and without the benefits of the present invention. As illustrated in FIG. 3(a), a comparison of entries from the revenue budget and the expenditure budget may show an imbalance because, while a base expenditure budget may have been defined as being in balance with a base revenue budget, posted revenue items may cause a corresponding increase in the expenditure budget. In FIG. 3(b), a comparison between the revenue and expenditure budgets illustrates a balance between them. RIB increases are recorded in both the expenditure and revenue budgets 250, 260 and, therefore, are reflected in any audits or other periodic balance checks of budget values.

As noted, the foregoing embodiments may provide a software implemented EMA system. As such, these embodiments may be represented by program instructions that are to be executed by a server or other common computing platform. One such platform 400 is illustrated in the simplified block diagram of FIG. 4. There, the platform 400 is shown as being populated by a processor 410, a memory system 420 and an input/output (I/O) unit 430. The processor 410 may be any of a plurality of conventional processing systems, including microprocessors, digital signal processors and field programmable logic arrays. In some applications, it may be advantageous to provide multiple processors (not shown) in the platform 400. The processor(s) 410 execute program instructions stored in the memory system. The memory system 420 may include any combination of conventional memory circuits, including electrical, magnetic or optical memory systems. As shown in FIG. 4, the memory system may include read only memories 422, random access memories 424 and bulk storage 424. The memory system not only stores the program instructions representing the various method described herein but also can store the data items on which these methods operate. The I/O unit 430 would permit communication with external devices.

Several embodiments of the present invention are specifically illustrated and described herein. However, it will be appreciated that modifications and variations of the present invention are covered by the above teachings and within the purview of the appended claims without departing from the spirit and intended scope of the invention.

1. A budgetary management method, comprising:
responsive to a new transaction that includes a revenue item, executing a RIB rule to determine an increase to expenditure budget generated therefrom, and
storing the budget increase in an identified node of an expenditure budget data structure, and
storing the budget increase in an identified node of a revenue budget data structure.

2. The budgetary management method of claim 1, wherein revenue budget increases are stored with a marking that they are to be excluded from RIB calculations for expenditure budget items.

3. The budgetary management method of claim 1, further comprising comparing the expenditure budget data structure and the revenue budget data structure to determine if values therein are in balance.

4. A reporting method for a budgetary control system, comprising:
responsive to a report template, retrieving expenditure budget values and revenue budget values from storage, and
generating a report that compares the expenditure budget values and the revenue budget values,
wherein the report template indicates whether values from revenue budget items generated according to RIB rules are to be included in the report.

5. The reporting method of claim 4, further comprising prior to the retrieving, storing revenue budget items in a database, each item including a marker to indicate whether the revenue budget item was generated according to a RIB rule.

6. A budgetary management system, comprising:
a RIB rule processing system that, responsive to a revenue item, generates a budget item representing an increase to an expenditure budget,
an expenditure budget database to store the budget item, and
a revenue budget database to store the budget item.

7. The budgetary management system of claim 6, wherein the expenditure budget database stores the budget item in a location identified by a RIB rule.

8. The budgetary management system of claim 6, wherein the revenue budget database stores the budget item in a location identified by a RIB rule.

9. The budgetary management system of claim 6, wherein the revenue budget database comprises at least two components: a first component to store planned revenue budget values and a second component to store budget increases generated from RIB rules.

10. The budgetary management system of claim 6 further comprising a report manager, responsive to a report definition, to generate a report from identified revenue budget items in the revenue budget database.

11. The budgetary management system of claim 10, wherein the report definition indicates that only planned revenue budget values are to be included in a report.

12. The budgetary management system of claim 10, wherein the report definition indicates that only RIB budget increases are to be included in a report.

13. The budgetary management system of claim 10, wherein the report definition indicates that planned revenue budget values and RIB budget increases are to be included in a report.

14. A computer readable medium comprising software stored thereon that, when executed, causes a processing system to:
execute, in response to a new transaction that includes a revenue item, a RIB rule to determine an increase to expenditure budget generated therefrom,
store the budget increase in an identified node of an expenditure budget data structure, and
store the budget increase in an identified node of a revenue budget data structure.

15. The computer readable medium of claim 14, wherein revenue budget increases are stored with a marking that they are to be excluded from RIB calculations for expenditure budget items.

16. The computer readable medium of claim 14, further comprising comparing the expenditure budget data structure and the revenue budget data structure to determine if values therein are in balance.

17. A computer readable medium comprising software stored thereon that, when executed, causes a processing system to:
retrieving, in response to a report template, expenditure budget values and revenue budget values from storage, and
generate a report that compares the expenditure budget values and the revenue budget values,
wherein the report template indicates whether values from revenue budget items generated according to RIB rules are to be included in the report.

18. The computer readable medium of claim 17, wherein the software further causes the processing system to store revenue budget items in a database, each item including a marker to indicate whether the revenue budget item was generated according to a RIB rule.
